(19) United States
(12) Patent Application Publication
(10) Pub. No.: US 2015/0062458 A1
(43) Pub. Date: Mar. 5, 2015

(54) INPUT DEVICE, DISPLAY DEVICE, AND ELECTRONIC DEVICE

(71) Applicant: KYOCERA Corporation, Kyoto-shi, Kyoto (JP)

(72) Inventors: Shinya Nakamura, Moriyama-shi (JP); Ryoichi Yokoyama, Kakogawa-shi (JP)

(21) Appl. No.: 14/389,297

(22) PCT Filed: Dec. 14, 2012
(86) PCT No.: PCT/JP2012/082540

§ 371 Date: Sep. 29, 2014

(30) Foreign Application Priority Data
Mar. 29, 2012 (JP) 2012-076855

(51) Int. Cl. G06F 3/047

(52) U.S. Cl. CPC G06F 3/047
USPC 349/12

(57) ABSTRACT

[Object] To provide an input device, a display device and an electronic device capable of reducing a possibility of degradation of detection sensitivity while realizing a small size.

[Solution] An input device (X1) includes a base (2), a first detection electrode (3a) provided on the base (2), a detection wire (8) provided on the base (2) and electrically connected to the first detection electrode (3a), an insulating layer (10) provided on the base (2) and covering the detection wire (8), a vibration body (13) disposed on the insulating layer (10), and a first conductive layer (11) provided between the vibration body (13) and the detection wire (8).

### TECHNICAL FIELD

The present invention relates to an input device, a display device, and an electronic device.

### BACKGROUND ART

In recent years, a tactile feedback technology for providing various senses of touch to a user, such as senses of pressure, rubbing touch, and skin touch when the user operates an input device has been known (for example, see Patent Literature 1). In the input device using such a tactile feedback technology, for example, a detection electrode, a detection wire electrically connected to the detection electrode, and a vibration body are provided on a base. In addition, the vibration body is located on the end side of the base relative to the detection wire.

In the input device in the related art described above, since the vibration body is located on the end side of the base relative to the detection wire, a size of the input device may increase laterally. Meanwhile, in order to decrease the size of the input device, it is necessary to cover detection wiring on the base with an insulating layer and then dispose the vibration body on the insulating layer. However, when the vibration body is disposed on the insulating layer, electrical noise generated by the vibration body may be picked up by the detection wiring, and detection sensitivity of the input device may be degraded.
Patent Literature 1: Japanese Unexamined Patent Application Publication No. 2003-122507

### SUMMARY OF INVENTION

The present invention has been made in view of such circumstances, and an object of the invention is to provide an input device, a display device, and an electronic device capable of reducing possibility of degradation of detection sensitivity while realizing reduction in size.

### SOLUTION TO PROBLEM

According to an aspect of the present invention, there is provided an input device including: a base; a detection electrode provided on the base; a detection wire provided on the base and electrically connected to the detection electrode; an insulating layer provided on the base and covering the detection wire; a vibration body disposed on the insulating layer; and a first conductive layer provided between the vibration body and the detection wire.

According to an aspect of the present invention, there is provided a display device including: the input device according to the present invention; a display panel disposed to face the input device; and a housing that accommodates the display panel.

According to an aspect of the present invention, there is provided an electronic device including the display device according to the present invention.

### BRIEF DESCRIPTION OF DRAWINGS

FIG. 1 is a plan view illustrating a schematic configuration of an input device according to Embodiment 1.

FIG. 2 is a plan view illustrating a schematic configuration of the input device according to Embodiment 1 and is a view seen through a base.

FIG. 3 is a cross-sectional view taken along line I-I illustrated in FIG. 2.

FIG. 4 is a cross-sectional view taken along the line II-II illustrated in FIG. 2.

FIG. 5 is a plan view of an enlarged area A1 surrounded by a dash-dot line illustrated in FIG. 2 and is a view seen through a second main surface of the base.

FIG. 6 is a cross-sectional view taken along the line III-III illustrated in FIG. 5.

FIG. 7 is a cross-sectional view taken along the line IV-IV illustrated in FIG. 5.

FIG. 8 is a flowchart diagram illustrating an operation example of the input device.

FIG. 9 is a cross-sectional view illustrating a schematic configuration of a display device according to Embodiment 1.

FIG. 10 is a perspective view illustrating a schematic configuration of a portable terminal according to Embodiment 1.

FIG. 11 is a plan view illustrating a schematic configuration of an input device according to Embodiment 2 and is a view seen through a base.

FIG. 12 is a plan view of an enlarged area B1 surrounded by a dash-dot line illustrated in FIG. 11 and is a view seen through from a second main surface of the base.

FIG. 13 is cross-sectional view taken along the line V-V illustrated in FIG. 12.

FIG. 14 is a plan view illustrating a schematic configuration of an input device according to Embodiment 3 and is a view seen through a base.

FIG. 15 is a plan view of an enlarged area C1 surrounded by a dash-dot line illustrated in FIG. 14 and is a view seen through from a second main surface of the base.

FIG. 16 is a plan view illustrating a schematic configuration of an input device according to Embodiment 4 and is a view seen through a base.

FIG. 17 is a plan view of an enlarged area D1 surrounded by a dash-dot line illustrated in FIG. 16 and is a view seen through from a second main surface of the base.

FIG. 18 is a cross-sectional view taken along the line VI-VI illustrated in FIG. 17.

FIG. 19 is a plan view illustrating a schematic configuration of an input device according to Embodiment 5 and is a view seen through a base.

FIG. 20 is a plan view of an enlarged area E1 surrounded by a dash-dot line illustrated in FIG. 19 and is a view seen through from a second main surface of the base.

FIG. 21 is a cross-sectional view taken along the line VII-VII illustrated in FIG. 20.

FIG. 22 is a plan view illustrating a schematic configuration of an input device according to Embodiment 6 and is a view seen through a base.

FIG. 23 is a cross-sectional view taken along the line VIII-VIII illustrated in FIG. 22.

### DESCRIPTION OF EMBODIMENTS

Hereinafter, embodiments of the present invention will be described with reference to the drawings.

For convenience of description, however, primary constituent members necessary for explaining the present invention among constituent members of embodiments of the present invention are simplified and illustrated in respective drawings referred to hereinafter. Therefore, an input device, a display device, and an electronic device according to the present invention may include any constituent member that is not illustrated in each drawing referred to by this disclosure.

### Embodiment 1

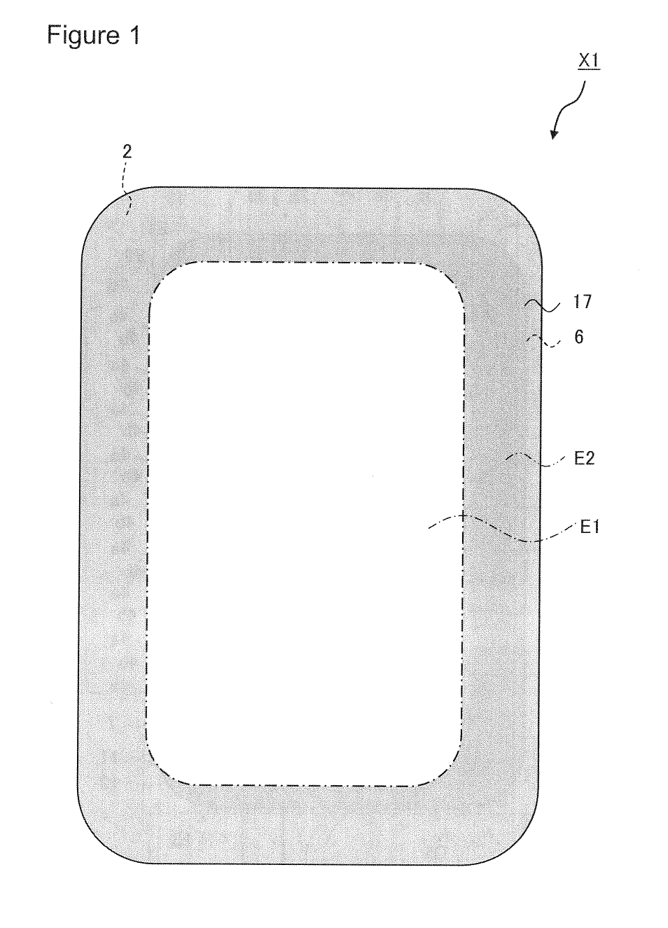

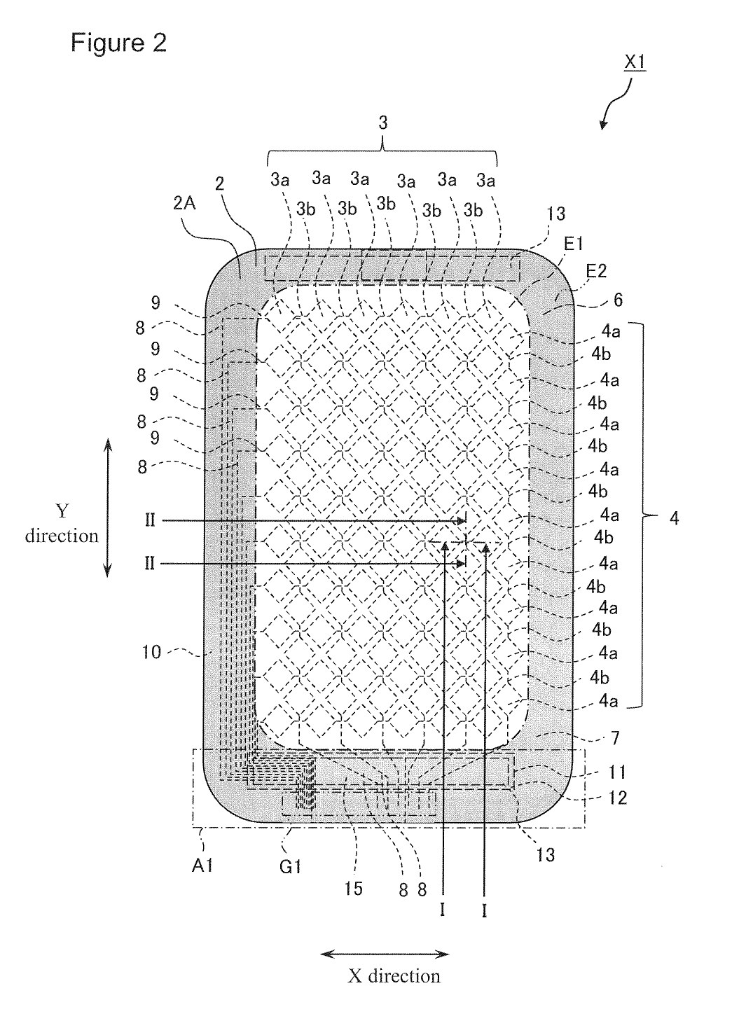

An input device X1 according to present embodiment is a projection type capacitive touch panel, as illustrated in FIGS. 1 and 2. The input device X1 includes an input area E1 and a non-input area E2. The input area E1 is an area in which a user can perform an input operation. The non-input area E2 is an area in which the user cannot perform an input operation. The non-input area E2 according to the present embodiment is located on the outer side of the input area E1 to surround the input area E1, but the invention is not limited thereto. For example, the non-input area E2 may be located within the input area E1.

In addition, the input device X1 is not limited to the projection type capacitive touch panel and may be, for example, a surface capacitive touch panel or a resistive film type touch panel.

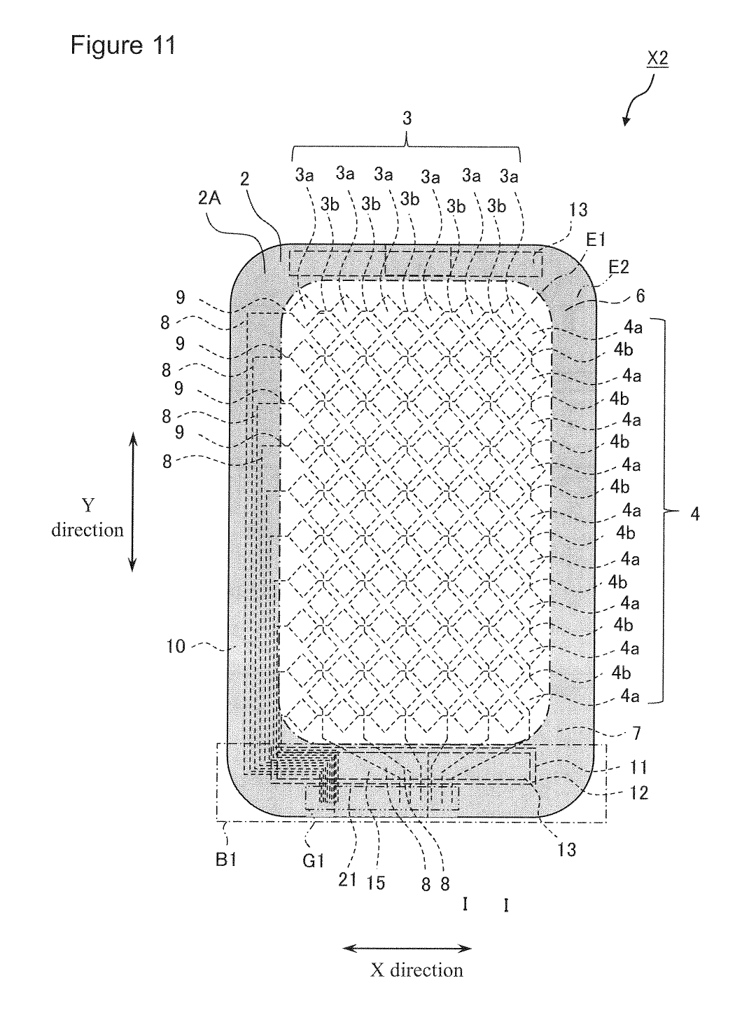

The input device X1 includes a base 2, as illustrated in FIGS. 1 to 4. In addition, for convenience of description, an insulator 5, an adhesive member 14, a conductive adhesive material 16, a protective sheet 17, and an adhesive layer 18 are not illustrated in FIG. 2. In addition, the same applies to FIGS. 11, 14, 16 and 19, which will be described below.

The base 2 serves to support a first detection electrode pattern 3, a second detection electrode pattern 4, and the insulator 5. The base 2 includes a first main surface 2A and a second main surface 2B. The first main surface 2A is located on the user side relative to the second main surface 2B. The second main surface 2B is located on the side opposite to the first main surface 2A. The base 2 is configured to have an insulation characteristic, and to have translucency for light incident in a direction crossing the first main surface 2A and the second main surface 2B of the base 2. A constituent material of the base 2 may include, for example, glass or plastic. In addition, in the present embodiment, the base 2 has a rectangular shape when viewed in plan, but the present invention is not limited thereto and may have, for example, a circular shape or a polygonal shape.

The first detection electrode pattern 3 generates capacitance between the first detection electrode pattern 3 and a finger F1 of the user approaching the first main surface 2A of the base 2 corresponding to the input area E1. The first detection electrode pattern 3 serves to detect an input position in a long-side direction (in FIG. 2, a Y direction) of the base 2 when viewed in plan. The first detection electrode pattern 3 is provided on the second main surface 2B of the base 2 corresponding to the input area E1. A plurality of first detection electrode patterns 3 are provided side by side in the Y direction. In addition, the first detection electrode pattern 3 includes first detection electrodes 3a and first inter-electrode wires 3b.

The first detection electrodes 3a serve to generate capacitance between the first detection electrodes 3a and the finger F1 of the user. A plurality of first detection electrodes 3a are provided side by side in plan in a short-side direction (in FIG. 2, an X direction) of the base 2. The first inter-electrode wires 3b serve to electrically connect the first detection electrodes 3a. The first inter-electrode wires 3b are provided between the first detection electrodes 3a that are adjacent each other.

The second detection electrode pattern 4 generates capacitance between the second detection electrode pattern 4 and the finger F1 of the user approaching the first main surface 2A of the base 2 corresponding to the input area E1. The second detection electrode pattern 4 serves to detect an input position in the X direction. The second detection electrode pattern 4 is provided on the second main surface 2B of the base 2 corresponding to the input area E1. A plurality of second detection electrode patterns 4 are provided side by side in the X direction. In addition, the second detection electrode pattern 4 includes second detection electrodes 4a and second inter-electrode wires 4b.

The second detection electrodes 4a serve to generate capacitance between the second detection electrodes 4a and the finger F1 of the user. A plurality of second detection electrodes 4a are provided side by side in the Y direction. The second inter-electrode wires 4b serve to electrically connect the second detection electrodes 4a. The second inter-electrode wires 4b are provided on the insulator 5 over the insulator 5 to be electrically insulated from the first inter-electrode wires 3b between the second detection electrodes 4a that are adjacent each other. Here, the insulator 5 is provided on the second main surface 2B of the base 2 to cover the first inter-electrode wires 3b. In addition, in the present embodiment, a plurality of the insulators 5 are provided to cover the plurality of first inter-electrode wires 3b, but the invention is not limited thereto and, for example, the insulator 5 may be provided over the second entire main surface 2B of the base 2 corresponding to the input area E1 to cover the plurality of first detection electrode patterns 3. In this case, the second detection electrodes 4a are also provided on the insulator 5, in addition to the second detection electrodes 4b. A constituent material of the insulator 5 may include, for example, a transparent resin such as an acrylic resin, an epoxy resin, a silicone resin, silicon dioxide, or silicon nitride.

Constituent materials of the first detection electrode pattern 3 and the second detection electrode pattern 4 described above may include conductive members having translucency. The conductive member having translucency may include, for example, indium tin oxide (ITO), indium zinc oxide (IZO), Al-doped zinc oxide (ATO), tin oxide, zinc oxide or a conductive polymer.

In a method of forming the first detection electrode pattern 3 and the second detection electrode pattern 4, for example, a film of the above-described material is formed on the second main surface 2B of the base 2 using a sputtering method, a deposition method, or a chemical vapor deposition (CVD) method. Also, a surface of this film is covered with a photosensitive resin, and a resultant film is patterned through exposure, developing, and etching processes to form the first detection electrode pattern 3 and the second detection electrode pattern 4.

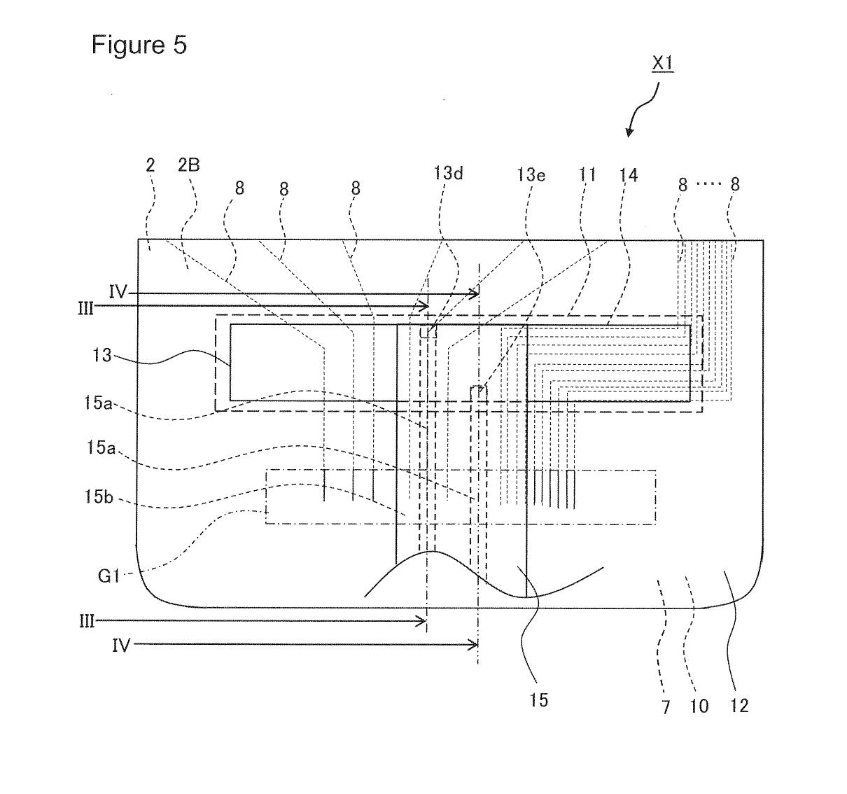

Next, a decorative layer 6, a first protective layer 7, detection wires 8, an insulating layer 10, a first conductive layer 11, a second protective layer 12, a vibration body 13, a wiring board 15, and a protective sheet 17 on the base 2 will be described with reference to FIGS. 5 to 7.

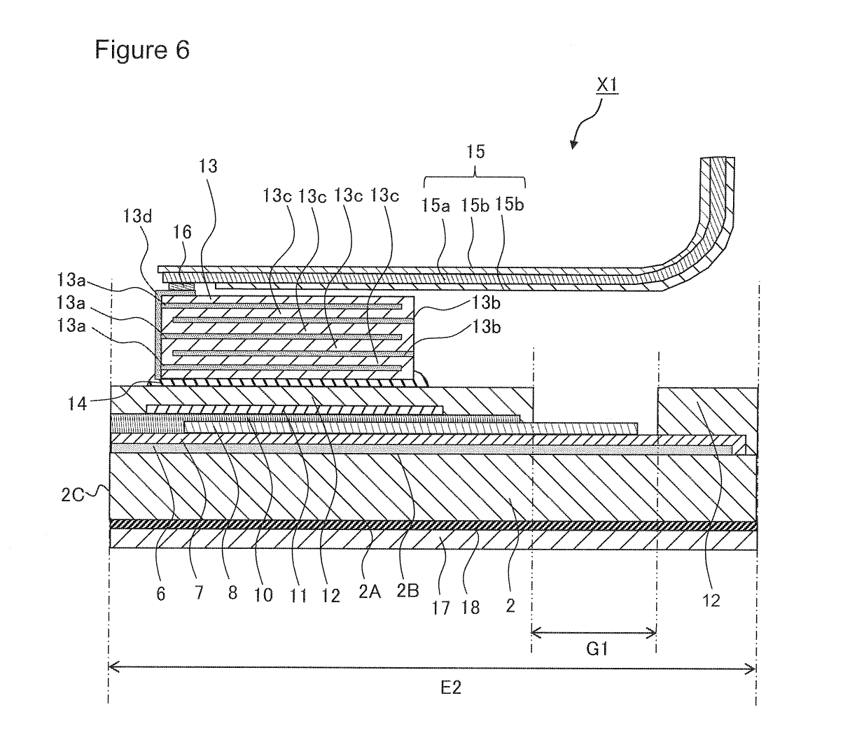

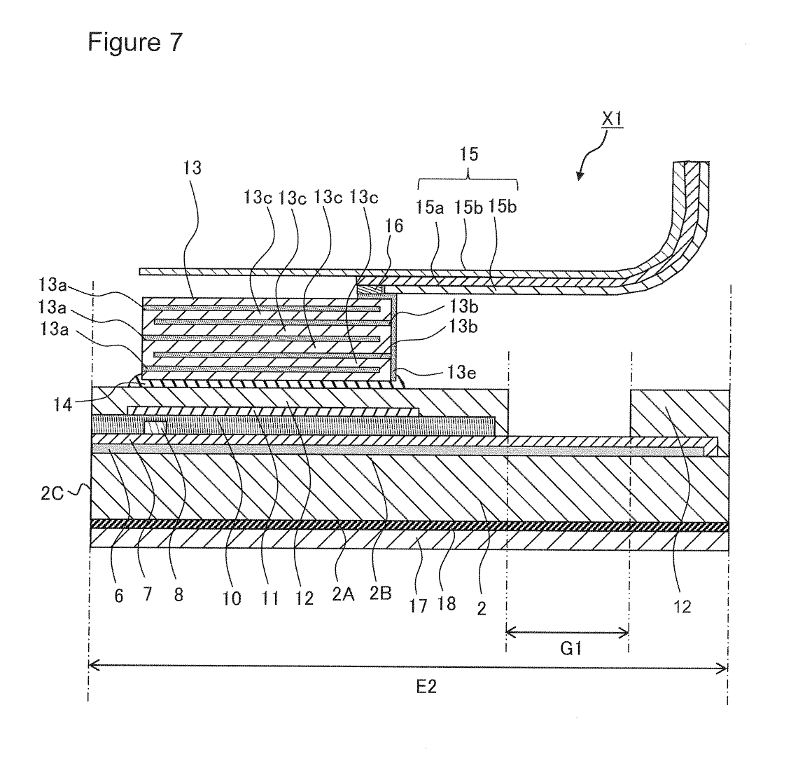

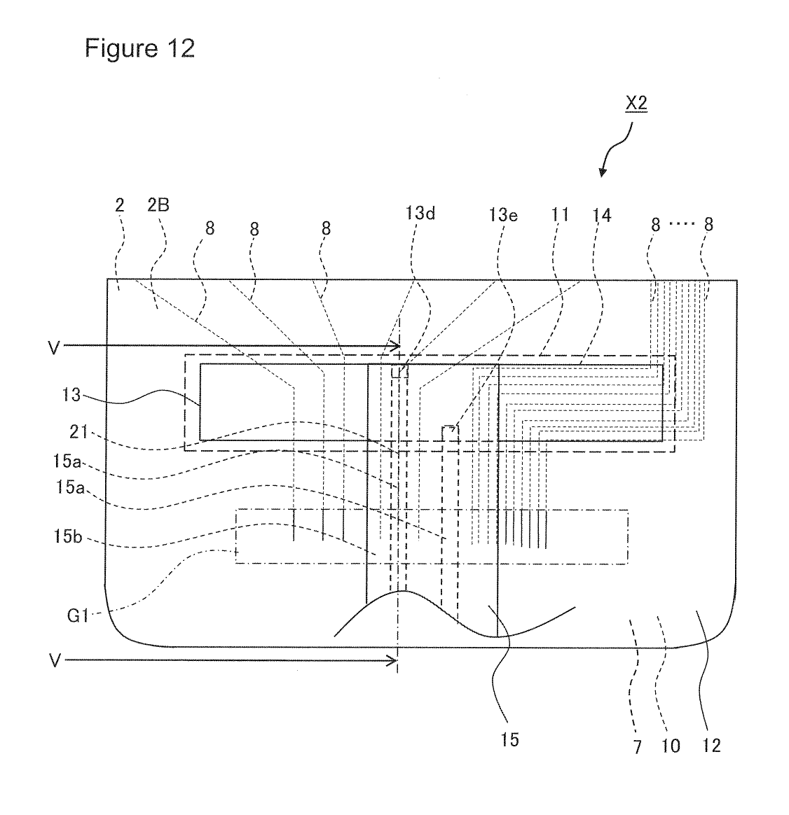

In addition, FIG. 5 is a plan view of an enlarged area A1 surrounded by a dash-dot line illustrated in FIG. 2 and is a view seen through from a second main surface side of the base. FIG. 6 is a cross-sectional view taken along the line III-III illustrated in FIG. 5. FIG. 7 is a cross-sectional view taken along the line IV-IV illustrated in FIG. 5. In addition, in FIG. 5, the decorative layer 6, the conductive adhesive material 16, the protective sheet 17, and the adhesive layer 18 are not illustrated for convenience of description. In addition, the same applies to FIGS. 12, 15, 17, and 20 that will be described below.

The decorative layer 6 serves to decorate the non-input area E2 of the input device X1. The decorative layer 6 is provided on the second main surface 2B of the base 2 corresponding to the non-input area E2. In addition, the decorative layer 6 may also be provided on the first main surface 2A of the base 2 corresponding to the non-input area E2. If the decorative layer 6 is provided on the first main surface 2A of the base 2 corresponding to the non-input area E2, when the vibration body 13 to be described below vibrates, a possibility of the vibration being attenuated by the decorative layer 6 can be reduced. A constituent material of the decorative layer 6 may include a material obtained by causing a coloring material to be contained in a resin material. The resin material may include, for example, an acrylic-based resin, an epoxy-based resin, or a silicone-based resin. The coloring material may include, for example, carbon, titanium, or chrome. In addition, the color of the decorative layer 6 is not limited to black and the decorative layer 6 may be colored with a color other than the black. A method of forming the decorative layer 6 may include, for example, a screen-printing method, a sputtering method, a CVD method, or a deposition method.

The first protective layer 7 serves to protect the decorative layer 6. Here, serving to protect the decorative layer 6 may include, for example, serving to protect the decorative layer 6 from corrosion due to moisture absorption or serving to reduce a possibility of a material of the decorative layer 6 being changed in quality. The first protective layer 7 is provided on the second main surface 2B of the base 2 so that the decorative layer 6 is covered with the first protective layer 7. A constituent material of the first protective layer 7 may include, for example, an acrylic-based resin, a silicone-based resin, a rubber-based resin, a urethane-based resin, or an inorganic compound containing silicon. A method for forming the first protective layer 7 may include, for example, a transfer printing method, a spin coating method or a slit coating method.

The detection wires 8 serve to apply a voltage to the first detection electrode pattern 3 and the second detection electrode pattern 4, and also serve to detect a change in capacitance generated between the first detection electrode pattern 3 and the finger F1 and between the second detection electrode pattern 4 and the finger F1. A plurality of detection wires 8 are located on the first protective layer 7. In addition, the detection wires 8 may be located on the decorative layer 6. Some of the plurality of detection wires 8 have one end connected to the first detection electrode pattern 3 via connection wires 9, and the other end located in an external conduction area G1. These some detection wires 8 extend in the Y direction. In addition, the other detection wires 8 among the plurality of detection wires 8 have one end connected to the second detection electrode pattern 4 via the connection wires 9 and the other end located in the external conduction area G1. Here, the connection wires 9 are located on the second main surface 2B of the base 2 and provided from the input area E1 to the non-input area E2. A constituent material of the connection wires 9 and a method of forming the connection wires 9 may include the same constituent material and method as those of the first detection electrode pattern 3 and the second detection electrode pattern 4.

The detection wires 8 are hard and are formed of a metal thin film in order to obtain high shape stability. A constituent material of the metal thin film may include, for example, an aluminum film, an aluminum alloy film, a film obtained by laminating a chrome film and an aluminum film, a film obtained by laminating a chrome film and an aluminum alloy film, a silver film, a silver alloy film, or a gold alloy film. A method of forming the metal thin film may include, for example, a sputtering method, a CVD method or a deposition method.

The insulating layer 10 serves to reduce a possibility of short-circuit of the detection wires 8. The insulating layer 10 is provided on the first protective layer 7 corresponding to the non-input area E2. The detection wires 8 are covered with the insulating layer 10. In addition, the insulating layer 10 is not present in the external conduction area G1. Therefore, the detection wires 8 are exposed from the insulating layer 10 in the external conduction area G1. A constituent material of the insulating layer 10 and a method of forming the insulating layer 10 are the same as those of the insulator 5 or the first protective layer 7. In addition, the insulating layer 10 may be formed at the same time as the insulator 5.

The first conductive layer 11 serves to reduce a possibility of electrical noise generated by the vibration body 13 being picked up by the detection wires 8. The first conductive layer 11 is provided between the vibration body 13 and the detection wires 8. Specifically, the first conductive layer 11 is located on the insulating layer 10 and overlaps the detection wires 8 when viewed in plan. Therefore, it is possible to reduce a possibility of short-circuit between the detection wires 8 and the first conductive layer 11. A constituent material of the first conductive layer 11 and a method of forming the first conductive layer 11 are the same as those of the first detection electrode pattern 3, the second detection electrode pattern 4, or the detection wires 8. In addition, the first conductive layer 11 may be formed at the same time as the first detection electrode pattern 3 or the second detection electrode pattern 4.

The second protective layer 12 serves to protect the first conductive layer 11. Here, serving to protect the first conductive layer 11 may include, for example, serving to protect the first conductive layer 11 from corrosion due to moisture absorption. The second protective layer 12 is provided between the vibration body 13 and the insulating layer 10. Specifically, the second protective layer 12 is provided on the insulating layer 10 corresponding to the non-input area E2. The first conductive layer 11 is covered with the second protective layer 12. In addition, the second protective layer 12 is not present in the external conduction area G1. In addition, the first detection electrode pattern 3 and the second detection electrode pattern 4 may be covered with the second protective layer 12, and may be provided on the second main surface 2B of the base 2 corresponding to the input area E1. If the first detection electrode pattern 3 and the second detection electrode pattern 4 are covered with the second protective layer 12, the first detection electrode pattern 3 and the second detection electrode pattern 4 can be protected so as not to be damaged due to an external shock. A constituent material of the second protective layer 12 and a method of forming the second protective layer 12 are the same as those of the first protective layer 7.

The vibration body 13 serves to vibrate the base 2 when a predetermined input operation by the user is detected. The vibration body 13 is disposed on the insulating layer 10. Specifically, the vibration body 13 is disposed on the second protective layer 12 corresponding to the non-input area E2 via the adhesive member 14. In addition, the vibration body 13 overlaps the detection wires 8 when viewed in plan. A constituent material of the adhesive member 14 may include, for example, an ultraviolet curing resin or a thermosetting resin. In addition, two vibration bodies 13 are arranged in the X direction near short opposite sides of the base 2 when viewed in plan as illustrated in FIG. 2. In addition, the number or the arrangement position of the vibration bodies 13 are not particularly limited.

The vibration body 13 is a piezoelectric element in which a plurality of first electrode layers 13a and a plurality of second electrode layers 13b are laminated alternately via a plurality of piezoelectric layers 13c. The vibration body 13 includes first surface electrode 13d electrically connected to the first electrode layers 13a. The vibration body 13 includes second surface electrodes 13e electrically connected to the second electrode layers 13b. In addition, the number of first electrode layers 13a and second electrode layers 13b is not particularly limited. In addition, in the present embodiment, the vibration body 13 is a piezoelectric element, but the present invention is not limited thereto. The vibration body 13 may be, for example, an electromagnetic vibration body, a spring, or a motor.

In the input device X1, the vibration body 13 is disposed on the insulating layer 10 via the first protective layer 7 and the adhesive member 14. Therefore, in the input device X1, it is possible to realize reduction in size of the input device X1 in comparison with the case in which the vibration body is disposed on the end side of the base relative to the detection wires. However, when the vibration body is disposed on the insulating layer, a spacing distance between the vibration body and the detection wires becomes relatively small. Therefore, there is a possibility of electrical noise from the vibration body being picked up by the detection wires. Therefore, in the input device X1, the first conductive layer 11 is provided between the vibration body 13 and the detection wires 8. Therefore, for example, even when an alternate current voltage is applied to the vibration body 13, electrical noise generated by the vibration body 13 can be shielded by the first conductive layer 11. Therefore, it is possible to reduce a possibility of the electrical noise being picked up by the detection wires 8 and detection sensitivity of the input device X1 being decreased. In addition, in this disclosure, “electrical noise is shielded by the first conductive layer 11” refers to the first conductive layer 11 shielding a part or all of the electrical noise. Thus, in the input device X1, it is possible to reduce a possibility of degradation of detection sensitivity while realizing reduction in size.

In addition, it is preferable for the first conductive layer 11 to overlap the entire vibration body 13 when viewed in plan, as in the present embodiment. If the first conductive layer 11 overlaps the entire vibration body 13 when viewed in plan, it is possible to further reduce a possibility of the electrical noise generated by the vibration body 13 being picked up by the detection wires 8.

In addition, it is preferable for the first conductive layer 11 to be set to a ground potential. When the first conductive layer 11 is set to the ground potential, for example, the potential of the first conductive layer 11 does not substantially change even when the alternate current voltage is applied to the vibration body 13. Therefore, it is possible to further reduce a possibility of electrical noise from the vibration body 13 being picked up by the detection wires 8 when the first conductive layer 11 is set to the ground potential. A method of setting the first conductive layer 11 to the ground potential may include, for example, a method of electrically connecting the first conductive layer 11 and a first housing 100 when the input device X1 is incorporated into a display device Y1.

The wiring board 15 serves to electrically connect the vibration body 13 and a tactile feedback driver (not illustrated). The wiring board 15 has control wires 15a and a covering layer 15b. The control wires 15a are covered with the covering layer 15b. In addition, a part of the control wires 15a is exposed from the covering layer 15b. For example, a flexible printed circuit board may be used as the wiring board 15. In addition, the control wires 15a exposed from the covering layer 15b are electrically connected to the first surface electrode 13d and the second surface electrode 13e via the conductive adhesive material 16. The conductive adhesive material 16 may include an anisotropic conductive material containing conductive particles in an insulating resin material, a solder, or the like.

The protective sheet 17 serves to protect the first main surface 2A of the base 2 so as not to be damaged due to contact of the finger F1 of the user. The protective sheet 17 is provided over the entire surface of the first main surface 2A of the base 2 corresponding to the input area E1 and the non-input area E2 via the adhesive layer 18. In addition, the protective sheet 17 may be provided on only the first main surface 2A of the base 2 corresponding to the input area E1. A constituent material of the protective sheet 17 may include, for example, glass or plastic. In addition, a constituent material of the adhesive layer 18 may include, for example, an acrylic-based adhesive material, a silicone-based adhesive material, a rubber-based adhesive material, or a urethane-based adhesive material.

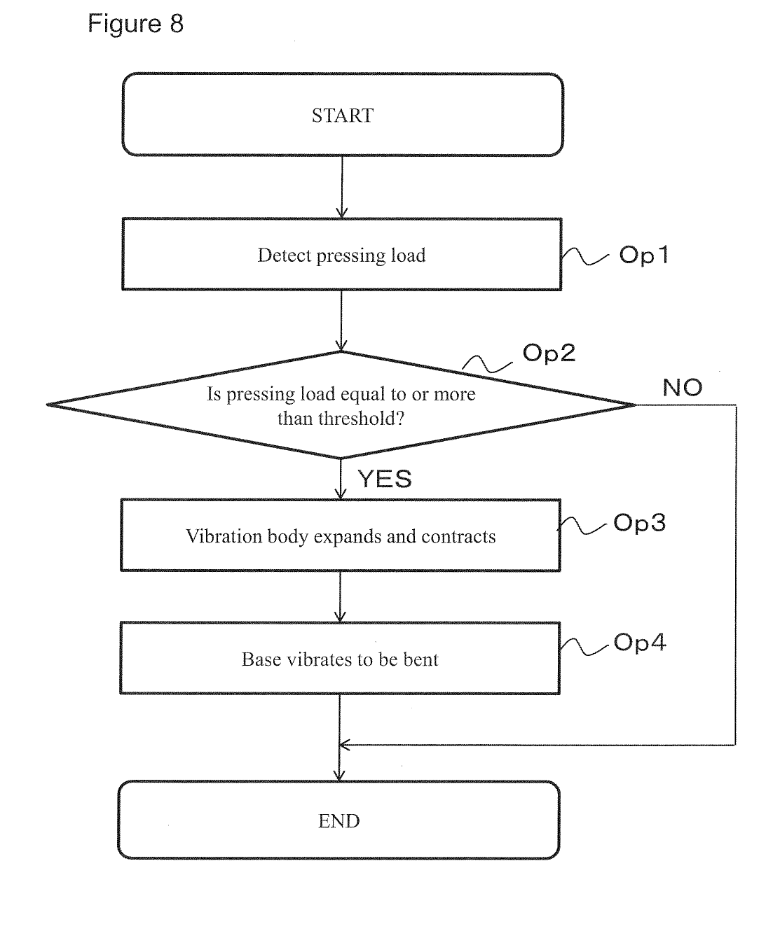

Next, an operation of the input device X1 will be described with reference to FIG. 8.

In addition, while an operation example of the input device X1 when a sense of pressure is provided to a user will be described hereinafter, the input device X1 is applicable to a case in which various senses of touch, such as a sense of rubbing touch and a sense of skin touch are provided, in addition to the sense of pressure.

As illustrated in FIG. 8, when the user presses the first main surface 2A of the base 2 corresponding to the input area E1 via the protective sheet 17, the vibration body 13 detects a pressing load against the base 2 (Op1). A load detection function of the vibration body 13 will be described herein. In other words, when the user presses the first main surface 2A of the base 2 corresponding to the input area E1 via the protective sheet 17, the base 2 is bent in a downward direction. In addition, the “down direction” in this disclosure refers to a direction from the first main surface 2A of the base 2 to the second main surface 2B. When the base 2 is bent in the down direction, the vibration body 13 is also bent in the down direction. In other words, a curvature amount of the vibration body 13 changes according to the pressing load against the base 2. In the present embodiment, since the vibration body 13 is a piezoelectric element, the vibration body 13 can convert the curvature amount to a voltage according to the curvature amount. As a result, the pressing load of the base 2 can be detected by the vibration body 13. In addition, while the example in which the load detection function is realized by the vibration body 13 has been described above, the invention is not limited thereto and, for example, the load detection function may be realized by a load sensor such as a strain sensor.

Also, the tactile feedback driver (not illustrated) determines whether the pressing load detected in Op1 is equal to or greater than a threshold when the operation of pressing the first main surface 2A by the user is an operation of pressing a predetermined input object (Op2). In addition, the tactile feedback driver is electrically connected to the vibration body 13 via the control wires 15a of the wiring board 15. In addition, the tactile feedback driver, for example, is mounted on the covering layer 15b of the wiring board 15 or on a circuit board 500 when the input device X1 is incorporated in the display device Y1.

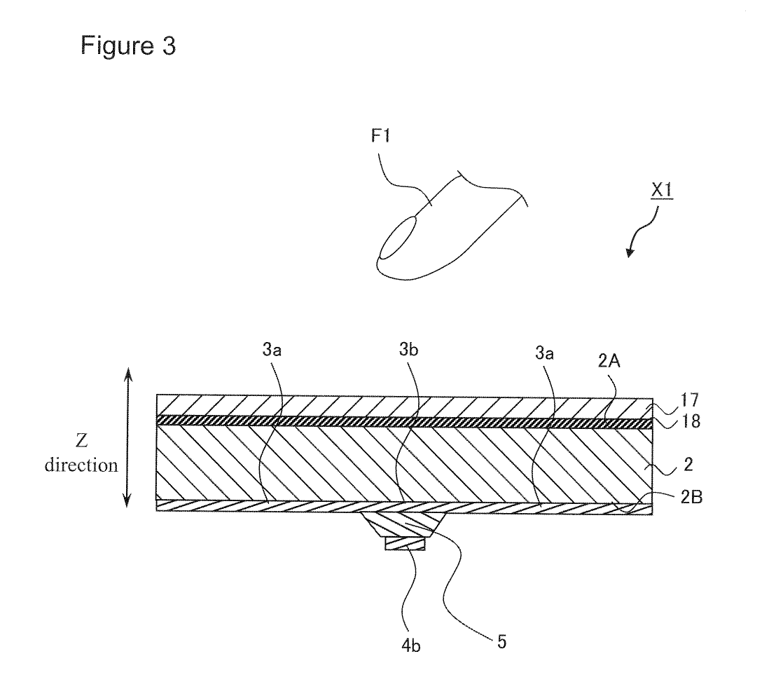

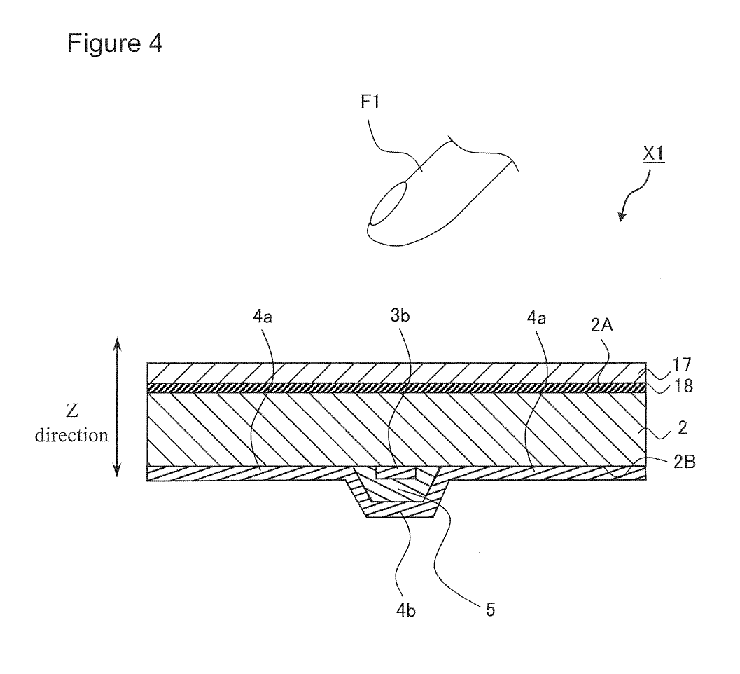

Also, if it is determined that the pressing load detected in Op1 is equal to or more than the threshold (YES in Op2), the tactile feedback driver causes the vibration body 13 to expand and contract in the X direction illustrated in FIG. 2 (Op3). Also, the base 2 vibrates to be bent in a thickness direction (a Z direction in FIGS. 3 and 4) due to the vibration body 13 expanding and contracting in Op3 (Op4). Accordingly, the sense of pressure is provided to the user, who has pressed the first main surface 2A. In contrast, if it is determined that the pressing load detected in Op1 is less than the threshold (NO in Op2), the tactile feedback driver ends the process of FIG. 8.

As described above, in the input device X1, it is possible to reduce a possibility of degradation of detection sensitivity while realizing reduction in size.

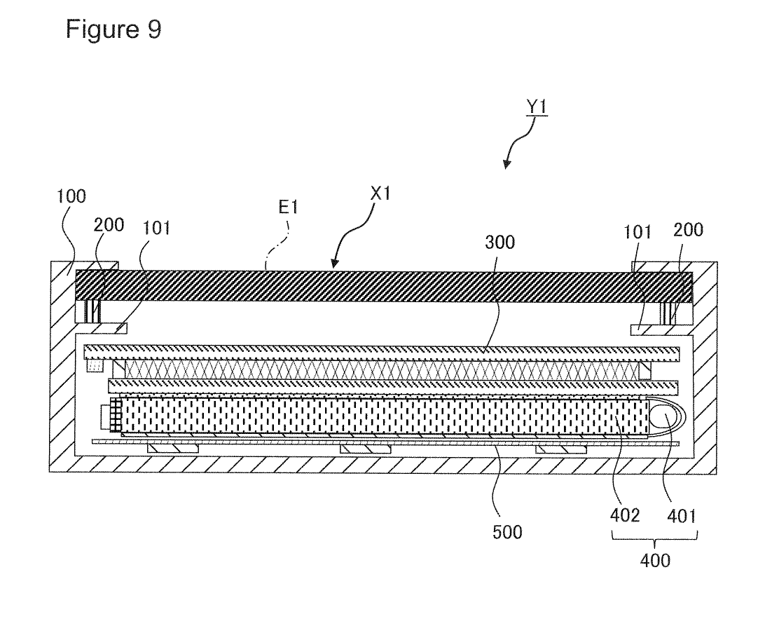

Next, the display device Y1 including the input device X1 will be described with reference to FIG. 9.

The display device Y1 according to the present embodiment includes the input device X1, the first housing 100, support members 200, a display panel 300, a backlight 400, and the circuit board 500, as illustrated in FIG. 9.

The input device X1 is accommodated in the first housing 100 so that the input area E1 is exposed. A constituent material of the first housing 100 may include, for example, a resin such as polycarbonate or a metal such as stainless steel or aluminum. In addition, the input device X1 is provided on a support portion 101 of the first housing 100 via the support members 200. Therefore, when the user presses the input device X1, the support members 200 become fulcrums and it is easy for the input device X1 to be bent in the down direction. Therefore, it is easy for the vibration body 13 to be bent in the down direction, and it is possible to increase detection sensitivity of the pressing load by the user. In addition, an arrangement position or the number of support members 200 is not particularly limited. A constituent material of the support members 200 may include, for example, a synthetic resin such as polyethylene terephthalate.

The display panel 300 serves to display an image or a video. The display panel 300 is provided to face the input device X1 and is accommodated in the first housing 100. In addition, the first housing 100 may be removed, and the input device X1 may be directly provided on the display panel 300 via the support members 200. In addition, the display panel 300 according to the present embodiment is a liquid crystal panel using a liquid crystal structure, but is not limited thereto and may be a plasma display, an organic EL display, a field emission display (FED), a surface-conduction electron-emitter display (SED), or an electronic paper.

The backlight 400 serves to cause light to be incident on an entire lower surface of the display panel 300. The backlight 400 is provided behind the display panel 300. The backlight 400 includes a light source 401 and a light guide plate 402. The light source 401 is a member serving to emit light toward the light guide plate 402, and includes light emitting diodes (LEDs). In addition, the light source 401 may not include LEDs and, for example, may include a cold cathode fluorescent lamp, a halogen lamp, a xenon lamp or an electro-luminescence (EL). The light guide plate 402 is a member serving to guide the light from the light source 401 to the entire lower surface of the display panel 300 substantially uniformly. In addition, the backlight 400 is unnecessary when a display panel using a self-light emitting element is used in place of the display panel 300.

The circuit board 500, for example, serves to support electronic parts such as the tactile feedback driver, a control circuit of the display panel 300, a control circuit of the backlight 400, resistors or capacitors. The circuit board 500 is located behind the backlight 400. A constituent material of the circuit board 500 may include, for example, a resin material.

Thus, the display device Y1 can input various pieces of information while providing senses of touch to the user when the user performs an input operation on the input area E1 while viewing the display panel 300 through the input device X1.

As described above, it is possible to reduce a possibility of degradation of detection sensitivity while realizing reduction in size since the display device Y1 includes the input device X1.

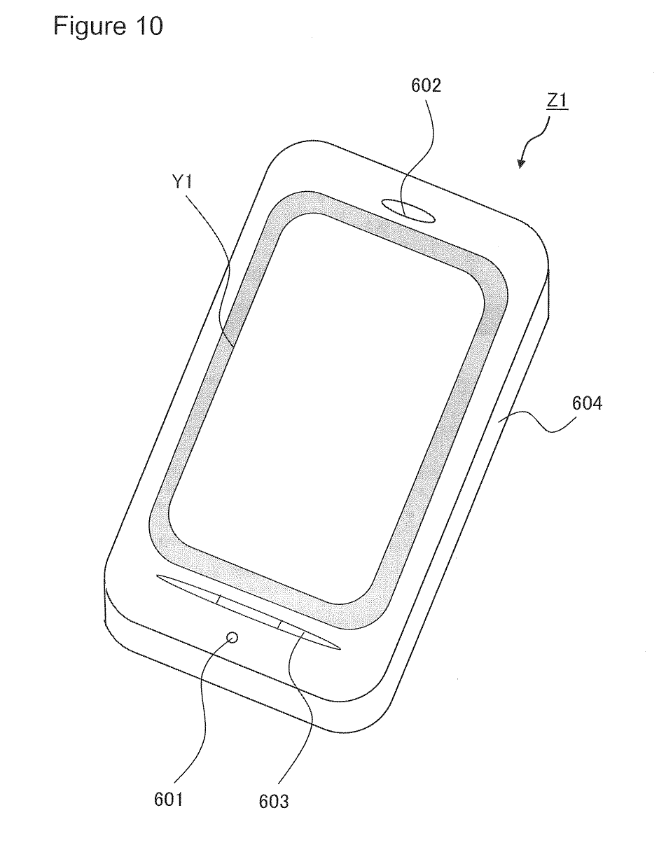

Next, a portable terminal Z1 including the display device Y1 will be described with reference to FIG. 10.

The portable terminal Z1 according to the present embodiment is a smartphone terminal, as illustrated in FIG. 10. In addition, the portable terminal Z1 is not limited to the smartphone terminal and may be, for example, a portable phone, a tablet terminal or a personal digital assistant (PDA).

The portable terminal Z1 includes the display device Y1, a sound input unit 601, a sound output unit 602, a key input unit 603, and a second housing 604.

The sound input unit 601 serves to input the voice of the user and includes, for example, a microphone. The sound output unit 602 serves to output a voice or the like from another party and includes, for example, an electromagnetic speaker or a piezoelectric speaker. In addition, the sound output unit 602 may be configured to vibrate the base 2 of the input device X1 using the vibration body 13 of the input device X1 to output the voice. The key input unit 603 includes mechanical keys. The key input unit 603 may be operation keys displayed on a display screen. The second housing 604 serves to accommodate the display device Y1, the sound input unit 601, the sound output unit 602, and the key input unit 603. In addition, the second housing 604 may be removed, and the sound input unit 601, the sound output unit 602, and the key input unit 603 may be accommodated in the first housing 100 of the display device Y1. A constituent material of the second housing 604 may include the same constituent material as that of the first housing 100.

In addition, the portable terminal Z1 may include a digital camera functional unit, a one-segment broadcasting tuner, a short-range wireless communication unit such as an infrared communication functional unit, a wireless LAN module, and various interfaces according to necessary functions, but illustration and description of details thereof will be omitted.

As described above, it is possible to reduce a possibility of degradation of detection sensitivity while realizing reduction in size since the portable terminal Z1 includes the display device Y1.

Here, the display device Y1 may be included in various electronic devices such as an electronic diary, a personal computer, a copier, a terminal device for games, a television, a digital camera, or a programmable indicator used for an industrial use, in place of the portable terminal Z1 described above.

In addition, one specific example of the present embodiment of the invention has been shown in the embodiment described above, and various modifications can be made. Hereinafter, some primary modification examples will be shown.

### Embodiment 2

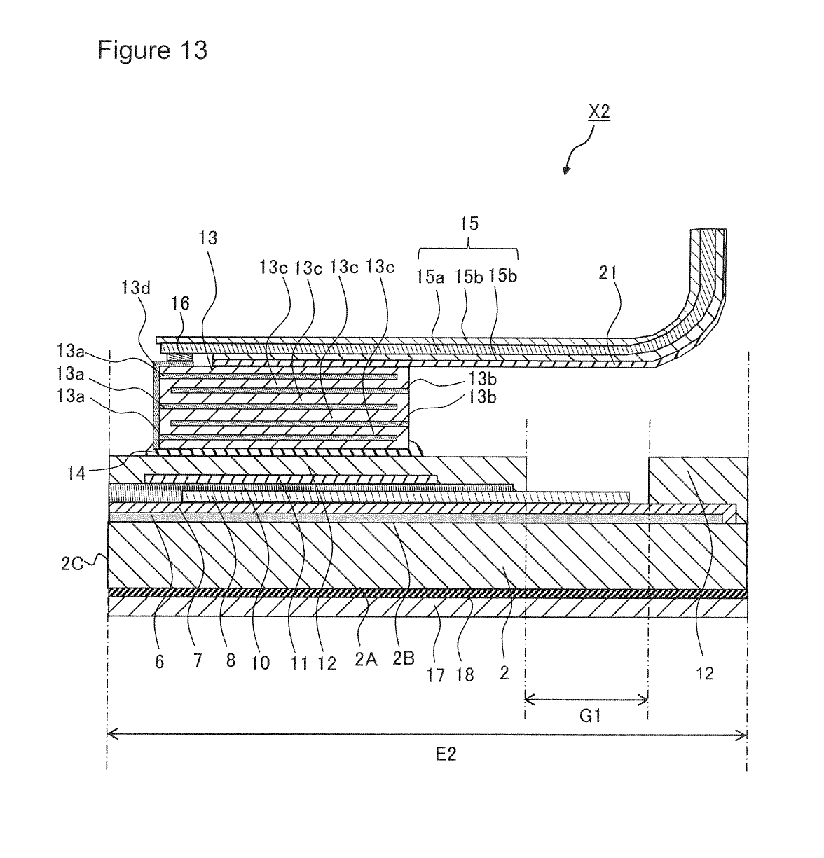

FIG. 11 is a plan view illustrating a schematic configuration of an input device X2 according to Embodiment 2 and is a view seen through a base 2. FIG. 12 is a plan view of an enlarged area B1 surrounded by a dash-dot line illustrated in FIG. 11 and is a view seen through from a second main surface 2B side of the base 2. FIG. 13 is a cross-sectional view taken along the line V-V illustrated in FIG. 12. In addition, in FIGS. 11 to 13, configurations having the same functions as those in FIGS. 2, 5, and 6 are denoted with the same reference signs and a detailed description thereof will be omitted.

The input device X2 further includes a second conductive layer 21, as illustrated in FIGS. 11 to 13. The second conductive layer 21 is provided on a covering layer 15b of a wiring board 15. In addition, a portion of the second conductive layer 21 is located between detection wires 8 and control wires 15a. Therefore, it is possible to reduce a possibility of electrical noise from the control wires 15a being picked up by the detection wires 8, for example, even when an alternate current voltage is applied to a vibration body 13 via the control wires 15a.

In addition, in the input device X2, the second conductive layer 21 is provided on the entire surface of the covering layer 15b facing the detection wires 8. Therefore, it is possible to further reduce a possibility of electrical noise from the control wires 15a being picked up by the detection wires 8. In addition, in the input device X2, it is preferable for the second conductive layer 21 to be set to a ground potential. When the second conductive layer 21 is set to the ground potential, the potential of the second conductive layer 21 does not substantially change even when an alternate current voltage is applied to the vibration body 13 via the control wires 15a. Therefore, it is possible to further reduce a possibility of electrical noise from the control wires 15a being picked up by the detection wires 8.

In addition, a constituent material of the second conductive layer 21 may include, for example, silver paste.

### Embodiment 3

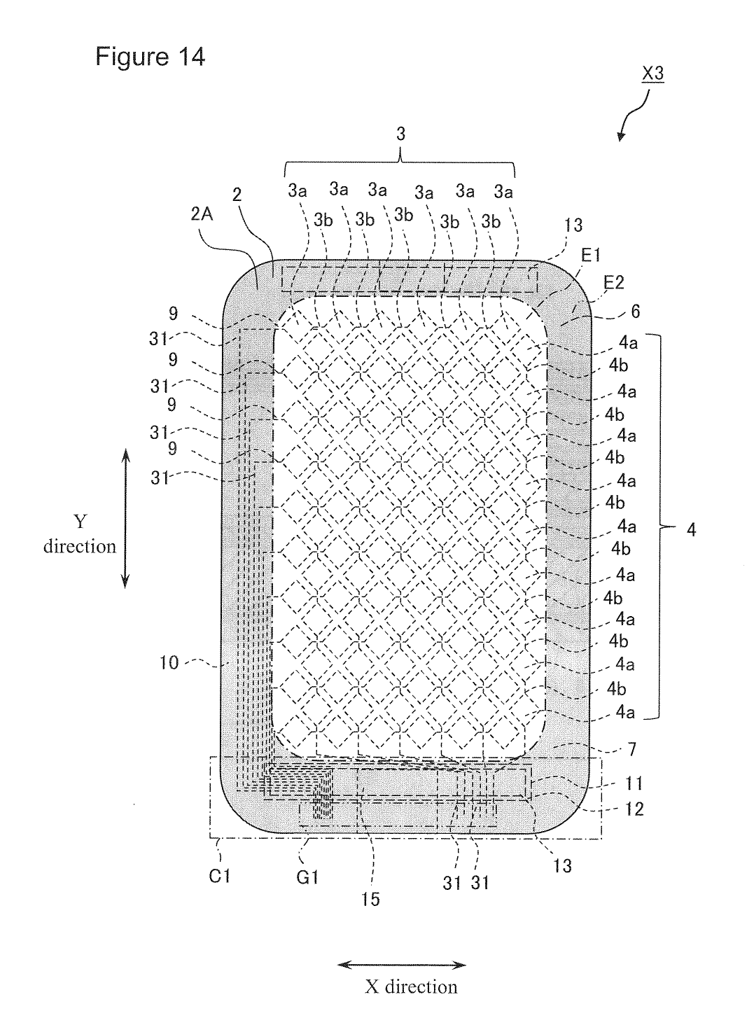

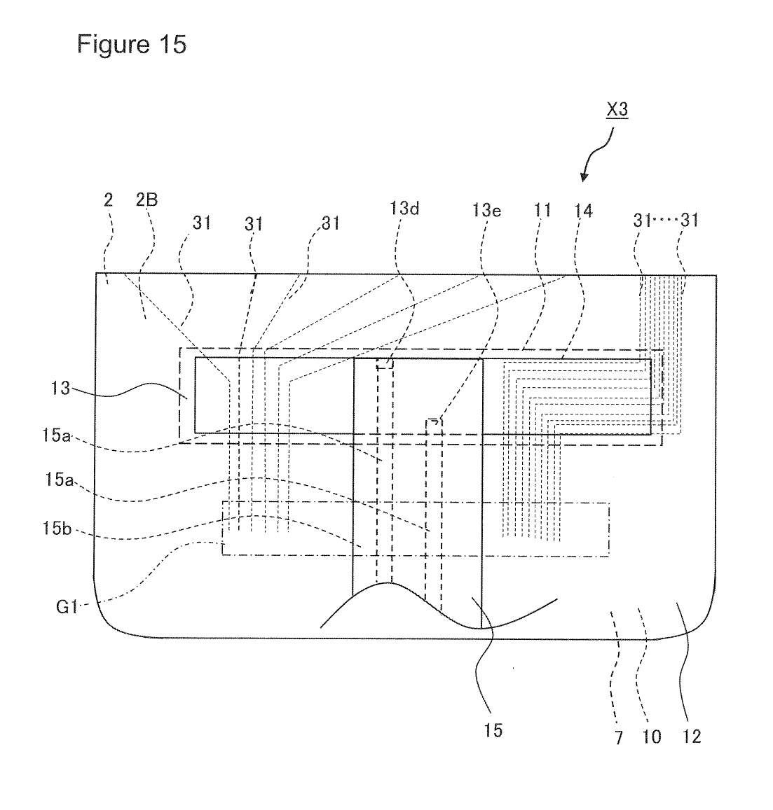

FIG. 14 is a plan view illustrating a schematic configuration of an input device X3 according to Embodiment 3 and is a view seen through a base 2. FIG. 15 is a plan view of an enlarged area C1 surrounded by a dash-dot line illustrated in FIG. 14 and is a view seen through from a second main surface 2B side of the base 2. In addition, in FIGS. 14 and 15, configurations having the same functions as those in FIGS. 2 and 5 are denoted with the same reference signs and a detailed description thereof will be omitted.

The input device X3 includes detection wires 31 in place of the detection wires 8 included in the input device X1, as illustrated in FIGS. 14 and 15. The detection wires 31 are located on a first protective layer 7. In addition, ends of the detection wires 8 are electrically connected to connection wires 9, and the other ends of the detection wires 8 are located in an external conduction area G1. Here, the detection wires 8 do not overlap control wires 15a when viewed in plan. Therefore, a spacing distance between the detection wires 31 and the control wires 15a can relatively increase. Therefore, it is possible to reduce a possibility of electrical noise from the control wires 15a being picked up by the detection wires 8, for example, even when an alternate current voltage is applied to the vibration body 13 via the control wires 15a.

### Embodiment 4

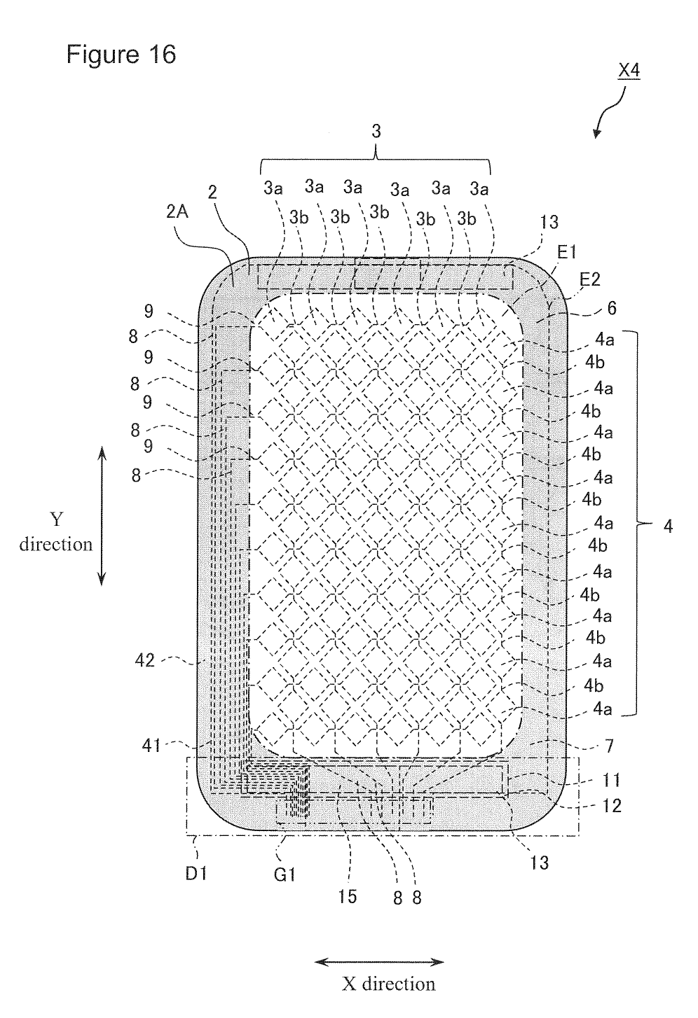

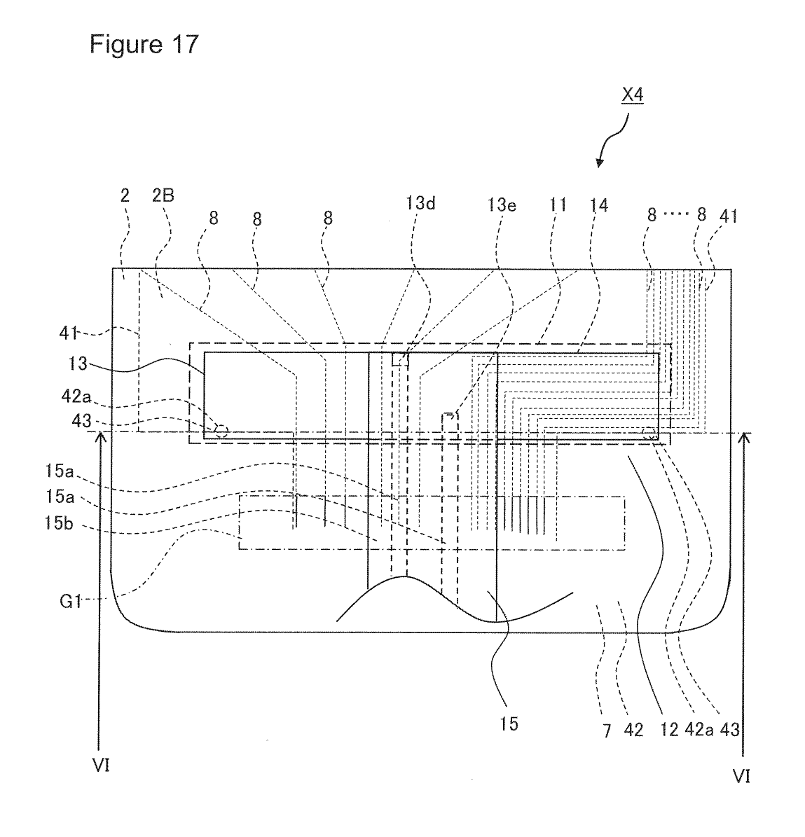

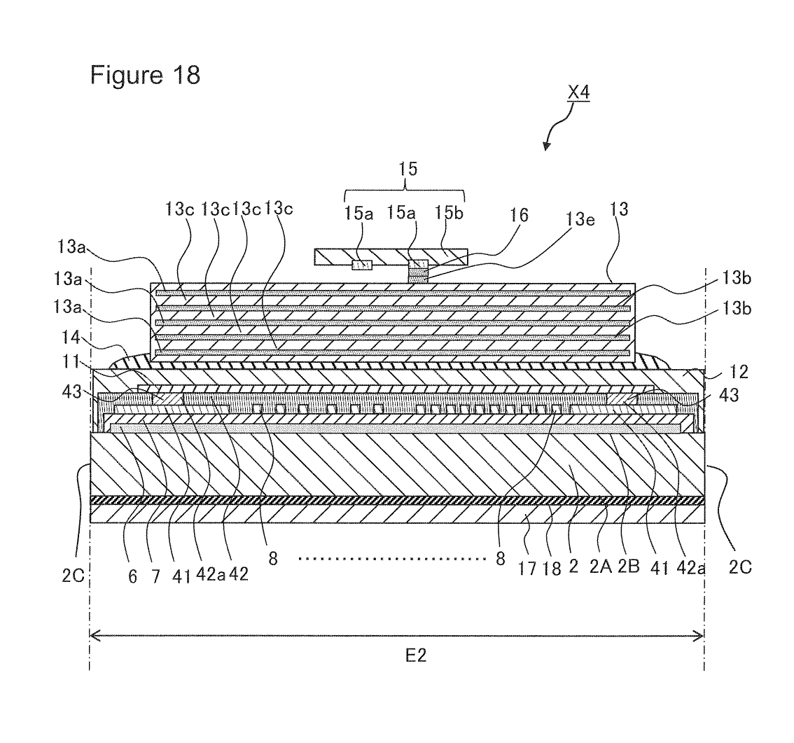

FIG. 16 is a plan view illustrating a schematic configuration of an input device X4 according to Embodiment 4 and is a view seen through a base 2. FIG. 17 is a plan view of an enlarged area D1 surrounded by a dash-dot line illustrated in FIG. 16 and is a view seen through from a second main surface 2B side of the base 2. FIG. 18 is a cross-sectional view taken along the line VI-VI illustrated in FIG. 17. In addition, in FIGS. 16 to 18, configurations having the same functions as those in FIGS. 2, 5, and 6 are denoted with the same reference signs and a detailed description thereof will be omitted.

The input device X4 further includes ground wires 41, as illustrated in FIGS. 16 to 18. The ground wires 41 are provided on the second main surface 2B of the base 2 corresponding to the non-input area E2 and are located on the end surface 2C side of the base 2 relative to the detection wires 8. Specifically, the ground wires 41 are provided on a first protective layer 7 corresponding to a non-input area E2 and located to surround detection wires 8 along the periphery of the base 2. Therefore, for example, when the input device X4 is incorporated into a display device, it is possible to remove electrical noise generated from the display device or from electronic parts or the like located around the input device X4, using the ground wires 41. Therefore, it is possible to further reduce a possibility of detection sensitivity of the input device X4 being degraded due to electrical noise being picked up by the detection wires 8. Here, in this disclosure, “to surround the detection wires 8” has a meaning including the fact that the detection wires 8 need not be completely surrounded by the ground wires 41 and, for example, the detection wires 8 may be surrounded by the ground wires 41 and an external conduction area G1. A constituent material of the ground wires 41 and a method of forming the ground wires 41 are the same as those of the detection wires 8.

In addition, the input device X4 includes an insulating layer 42 in place of the insulating layer 10 included in the input device X1. The insulating layer 42 is provided on the first protective layer 7 corresponding to the non-input area E2, and the detection wires 8 are covered with the insulating layer 42. The insulating layer 42 includes openings 42a between the detection wires 8 and a first conductive layer 11. Conductive members 43 are buried in the openings 42a. In addition, the first conductive layer 11 is electrically connected to the ground wires 41 through the conductive members 43. Therefore, it is possible to reduce a resistance value of the first conductive layer 11 while setting the first conductive layer 11 to a ground potential. Therefore, it is possible to further reduce a possibility of electrical noise from the vibration body 13 being picked up by the detection wires 8. In addition, in the input device X4, the conductive members 43 is provided in two places, but the invention is not limited thereto and the conductive members 43 may be provided in several places. In addition, the conductive members 43 may be formed integrally with the detection wires 8. A constituent material of the conductive members 43 may include, for example, solder, silver paste, or the same constituent material as that of the detection wires 8.

### Embodiment 5

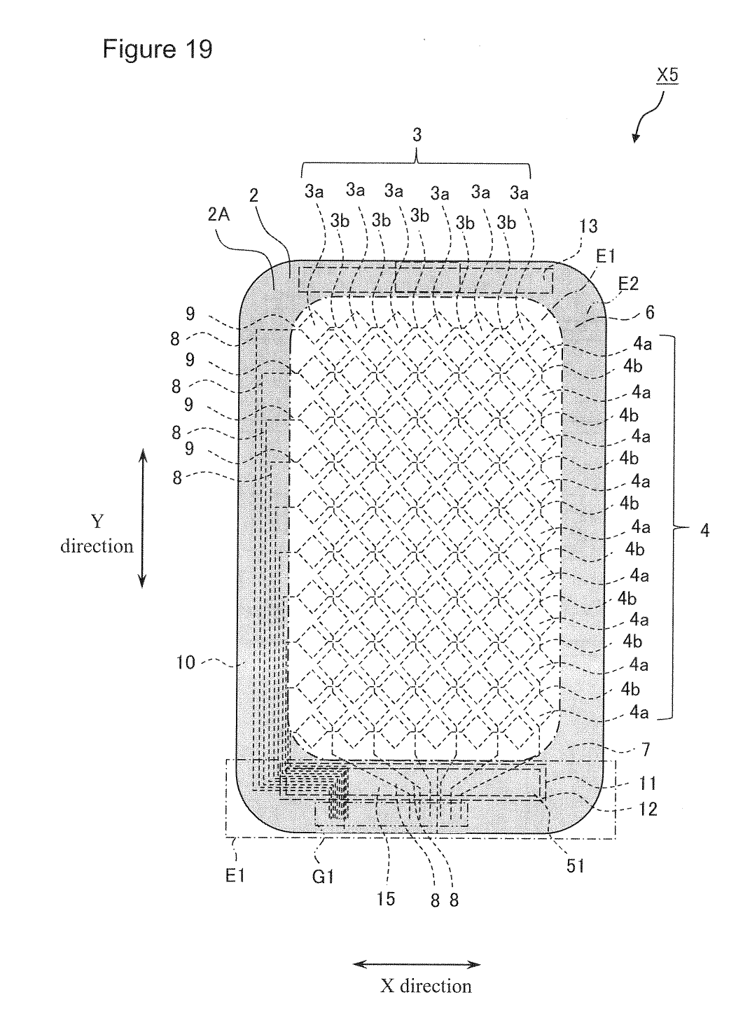

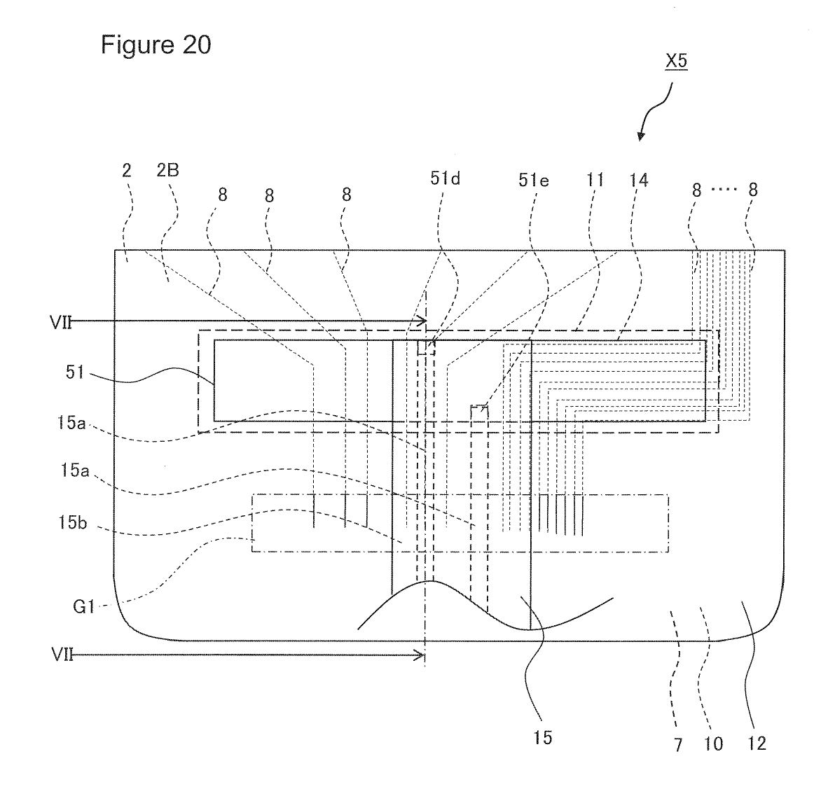

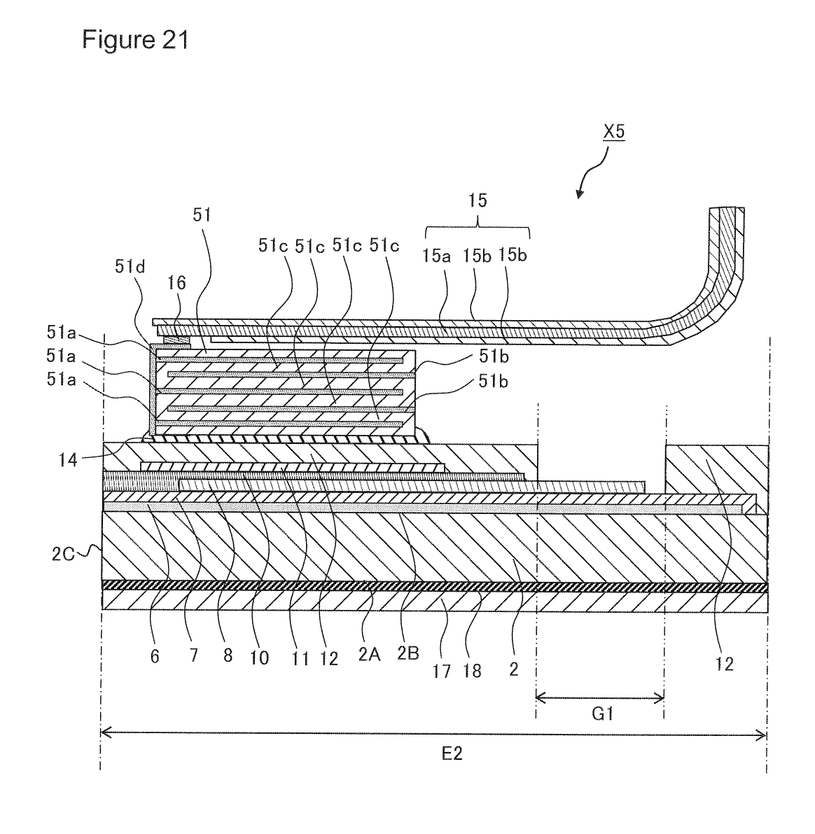

FIG. 19 is a plan view illustrating a schematic configuration of an input device X5 according to Embodiment 5 and is a view seen through a base 2. FIG. 20 is a plan view of an enlarged area E1 surrounded by a dash-dot line illustrated in FIG. 19 and is a view seen through from a second main surface 2B side of the base 2. FIG. 21 is a cross-sectional view taken along the line VII-VII illustrated in FIG. 20. In addition, in FIGS. 19 to 21, configurations having the same function as those in FIGS. 2, 5, and 6 are denoted with the same reference signs and a detailed description thereof will be omitted.

The input device X5 includes a vibration body 51 in place of the vibration body 13 included in the input device X1, as illustrated in FIGS. 19 to 21. In the vibration body 51, a plurality of first electrode layers 51a and a plurality of second electrode layers 51b are laminated alternately via a plurality of piezoelectric layers 51c. In addition, the first electrode layers 51a are electrically connected to a first surface electrode 51d, and the second electrode layers 51b are electrically connected to a second surface electrode 51e. The plurality of first electrode layers 51a are set to a ground potential via the first surface electrode 51d and control wires 15a of a wiring board 15.

Here, the electrode layer located on the side nearest to detection wires 8 among the plurality of first electrode layers 51a and the plurality of second electrode layers 51b is the first electrode layer 51a. Therefore, for example, even when an alternate current voltage is applied to the vibration body 51, it is possible to further reduce a possibility of electrical noise from the vibration body 51 being picked up by the detection wires 8. In addition, the surface electrode located on the side nearest to a first detection electrode pattern 3 and a second detection electrode pattern 4 among the first surface electrode 51d and the second surface electrode 51e is the first surface electrode 51d. Therefore, for example, even when an alternate current voltage is applied to the vibration body 51, it is possible to reduce a possibility of electrical noise from the vibration body 51 being picked up by the first detection electrode pattern 3 and the second detection electrode pattern 4.

### Embodiment 6

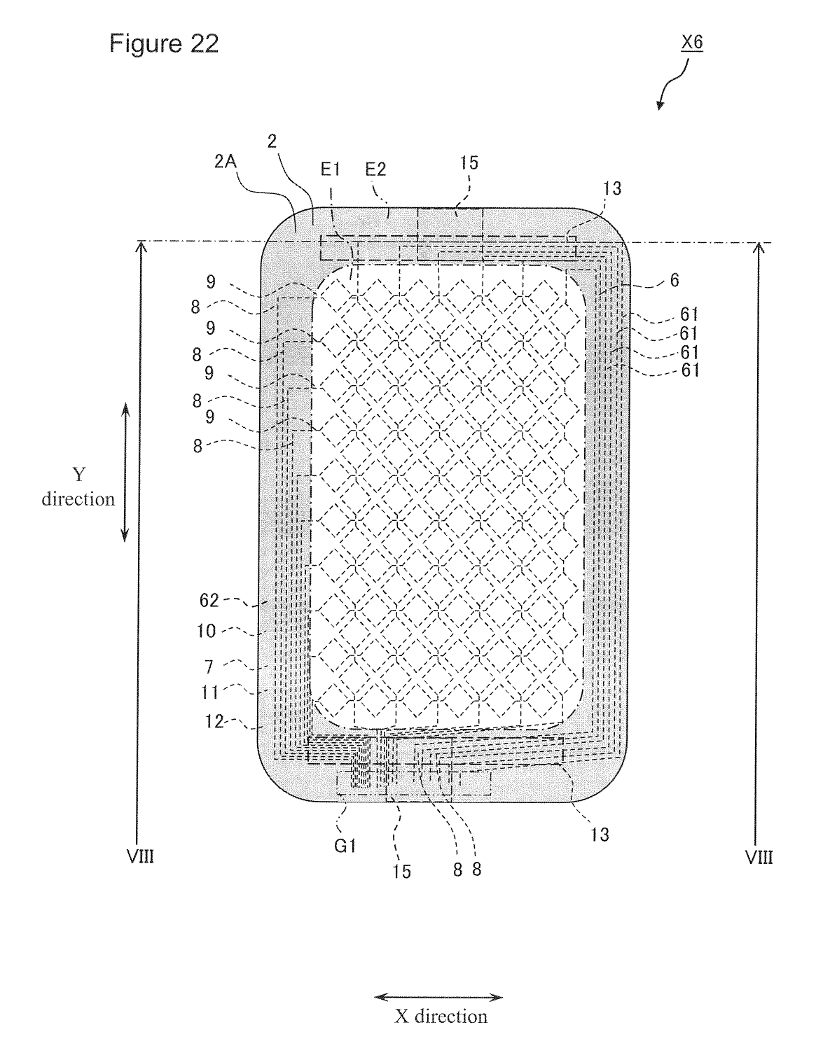

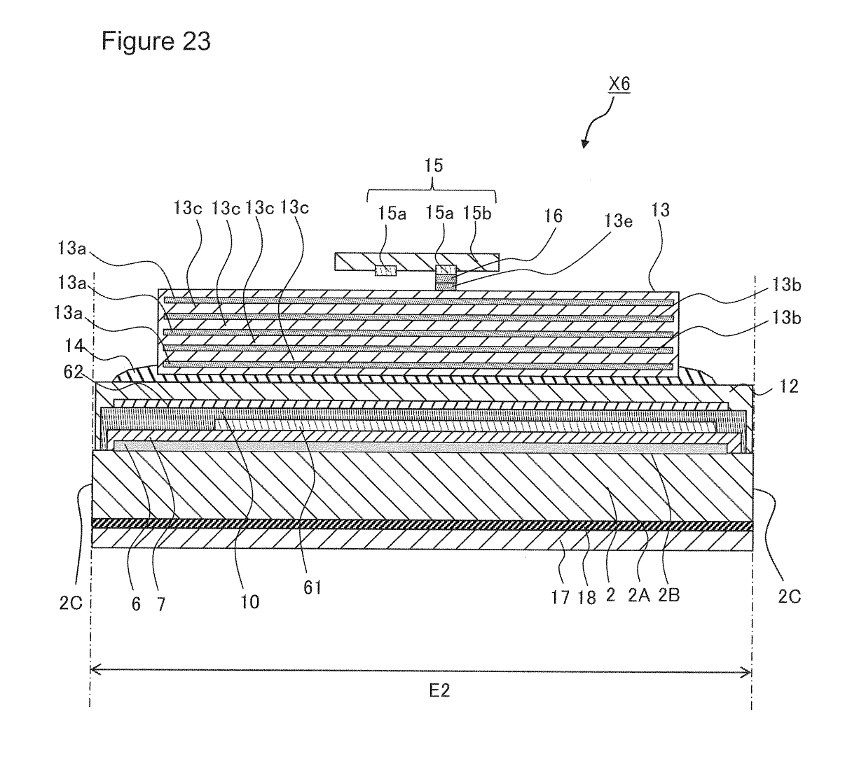

FIG. 22 is a plan view illustrating a schematic configuration of an input device X6 according to Embodiment 6 and is a view seen through a base 2. FIG. 23 is a cross-sectional view taken along the line VIII-VIII illustrated in FIG. 22. In addition, in FIGS. 22 and 23, configurations having the same functions as those in FIGS. 2 and 18 are denoted with the same reference signs and a detailed description thereof will be omitted.

The input device X6 further includes auxiliary wires 61, as illustrated in FIGS. 22 and 23. A plurality of auxiliary wires 61 are located on a first protective layer 7. The auxiliary wires 61 are electrically connected to a second detection electrode pattern 4. Specifically, ends of the auxiliary wires 61 are located on the side opposite to detection wires 8 with the second detection electrode pattern 4 sandwiched therebetween, and are electrically connected to the second detection electrode pattern 4. In addition, the other ends of the auxiliary wires 61 are located in an external conduction area G1. Here, since the second detection electrode pattern 4 is longer than the first detection electrode pattern 3, there is a possibility of increase in wiring resistance. In Embodiment 6, since the second detection electrode pattern 4 is electrically connected to the detection electrodes 8 and the auxiliary wires 61, it is possible to reduce a possibility of increase in wiring resistance. The auxiliary wires 61 overlaps a vibration body 15 located along a short side on the upper side of the base 2, when viewed in plan.

Here, the input device X6 includes a first conductive layer 61 in place of the first conductive layer 11 included in the input device X1. The first conductive layer 61 is provided on the insulating layer 10. The first conductive layer 61 is located over the entire non-input area E2 other than the external conduction area G1. Therefore, the first conductive layer is located between the auxiliary wires 61 and the vibration body 15 located along the short side on the upper side of the base 2. Therefore, in the input device X6, it is possible to reduce a possibility of electrical noise generated by the vibration body 15 being picked up by the auxiliary wires 61.

In addition, the first conductive layer 61 overlaps the detection wires 8 in an area other than the area in which the vibration body 15 is located, when viewed in plan. Therefore, it is possible to reduce a possibility of electrical noise generated from the display panel 300 being picked up by the detection wires 8, for example, when the input device X6 is incorporated in the display device Y1 in place of the input device X1.

### Embodiment 7

In addition, while Embodiments 1 to 6 described above have been individually described in detail in this disclosure, the invention is not limited thereto and the example in which matters described individually in Embodiments 1 to 6 described above are combined appropriately has been also described. In other words, the input device according to the present invention is not limited to the input devices X1 to X6 and includes an input device in which the matters individually described in Embodiments 1 to 6 described above are appropriately combined.

In addition, while the display device Y1 including the input device X1 has been described in the present embodiment, the invention is not limited thereto and the input devices X2 to X6 may be adopted in place of the input device X1.

### Embodiment 8

Further, while the example in which the input device is applied to the tactile feedback technology has been described in Embodiments 1 to 7 described above, the present invention is not limited thereto. For example, the present invention is also applicable to a speaker technology for outputting a voice by vibrating the base so as to be bent or a bone conduction technology capable of recognizing a voice through bone conduction, in addition to the tactile feedback technology. In addition, in this disclosure, the “bone conduction technology” has a meaning also including a cartilage conduction technology. Here, the “cartilage conduction” means transmission of vibration at a frequency corresponding to a voice signal to the cartilage of the outer ear and stimulation of the inner ear via its inner bone to transmit the signal to the auditory nerve.

### REFERENCE SIGNS LIST

X1-X6 INPUT DEVICE
Y1 DISPLAY DEVICE
Z1 PORTABLE TERMINAL (ELECTRONIC DEVICE)
2 BASE
2C END SURFACE OF BASE
3a FIRST DETECTION ELECTRODES
4a SECOND DETECTION ELECTRODES
8, 31 DETECTION WIRES
10, 42 INSULATING LAYER
11, 62 FIRST CONDUCTIVE LAYER
12 SECOND PROTECTIVE LAYER
13, 51 VIBRATION BODY
13a, 51a FIRST ELECTRODE LAYER
13b, 51b SECOND ELECTRODE LAYER
13c, 51c PIEZOELECTRIC LAYER
15 WIRING BOARD
15a CONTROL WIRES
15b COVERING LAYER
21 SECOND CONDUCTIVE LAYER
41 GROUND WIRES
61 AUXILIARY WIRES
100 FIRST HOUSING (HOUSING)
300 DISPLAY PANEL

1. An input device comprising:
a base;
a detection electrode provided on the base;
a detection wire provided on the base and electrically connected to the detection electrode;
an insulating layer provided on the base and covering the detection wire;
a vibration body disposed on the insulating layer; and
a first conductive layer provided between the vibration body and the detection wire.

2. The input device according to claim 1, further comprising:
a protective layer provided between the vibration body and the insulating layer,
wherein the first conductive layer is provided on the insulating layer and covered with the protective layer.

3. The input device according to claim 1, further comprising:
a wiring board including a control wire that is electrically connected to the vibration body, and a covering layer that covers the control wire; and
a second conductive layer provided on the covering layer,
wherein at least a portion of the second conductive layer is located between the detection wire and the control wire.

4. The input device according to claim 1, further comprising:
a wiring board including a control wire that is electrically connected to the vibration body, and a covering layer that covers the control wire,
wherein the detection wire does not overlap the control wire when viewed in plan.

5. The input device according to claim 1, further comprising:
a ground wire provided on the base and located on the end side of the base relative to the detection wire.

6. The input device according to claim 5,
wherein the first conductive layer is electrically connected to the ground wire.

7. The input device according to claim 1,
wherein the vibration body includes a plurality of piezoelectric layers and a plurality of electrode layers, the piezoelectric layers and the electrode layers are laminated alternately, and
an electrode layer of the plurality of electrode layers which is located nearest to the detection wire is set to ground potential.

8. The input device according to claim 1,
wherein the first conductive layer overlaps the detection wire, when viewed in plan, in an area other than an area in which the vibration body is located.

9. The input device according to claim 1,
wherein the first conductive layer overlaps the entire vibration body when viewed in plan.

10. A display device comprising:
the input device according to claim 1;
a display panel disposed to face the input device; and
a housing that accommodates the display panel.

11. An electronic device including the display device according to claim 10.
